(19) United States
(12) Patent Application Publication
(10) Pub. No.: US 2008/0045396 A1
(43) Pub. Date: Feb. 21, 2008

(54) Centrifuge Comprising a Plurality of Centrifugal Drums Provided with Packets of Disks

(76) Inventors: Poul-Erik Aagaard, Sporup (DK); Klaus-Dieter Broker, Oelde (DE)

Correspondence Address: BARNES & THORNBURG LLP, 750-17TH STREET NW, SUITE 900, WASHINGTON, DC, 20006-4675, US

(21) Appl. No.: 10/563,981

(22) PCT Filed: Jul. 8, 2004
(86) PCT No.: PCT/EP04/07518

§ 371 Date: Aug. 14, 2007

(30) Foreign Application Priority Data
Jul. 11, 2003 (DE) 103 31 732.5

(51) Int. Cl. B04B 5/02

(52) U.S. Cl. 494/50; 494/43

(57) ABSTRACT

A centrifuge includes at least two centrifugal drums, each drum including a disc stack and each drum being rotatable about first and second axes of rotation. The first axis of rotation extends through a center of gravity of and is within each drum. The second axis of rotation is situated outside each drum.

The invention relates to a centrifuge with a rotatable centrifugal drum having a stack of discs.

Separators of this type are known in many different embodiments, for example, from German Patent Document DE 200 10 743 U1.

It is an object of the invention to improve this state of the art such that separators are created which have at least partially improved characteristics and preferably new usage possibilities.

The invention achieves this task by means of the object of claim 1 and creates a new type of centrifuge which has many different advantages in comparison with the state of the art.

According to claim 1, the centrifuge has at least two centrifugal drums which can respectively be rotated about two axes of rotation, in each case only one of the axes of rotation extending through the center of gravity of the centrifugal drums such that one of the axes of rotation is in each case situated inside the at least one or more centrifugal drum(s) and the additional axis of rotation is situated outside the centrifugal drum(s), the two axes of rotation extending through the center of gravity preferably being aligned parallel to one another—particularly situated in a plane, and one disc stack respectively being inserted in the drums.

This surprising idea of a “separator” with several drums which each rotate about two axes of rotation and which each have a stack of discs, results in new effects in the interior of the centrifugal drums which can be advantageously utilized, for example, for optimizing the solids discharge.

From the state of the art, filter centrifuges are known, for example, which have two filter drums (German Patent Document DE 3131329 A1).

German Patent Document DE 3 092 579 also shows an evacuating system for open drums which can be rotated about an axis of symmetry and, during the evacuation, are tilted about a second axis extending through the drum.

German Patent Document DE 1 432 853 OS shows a method and a device for separating substances by gyrofugation, in the case of which one drum is rotated about its axis of symmetry and is moved about another axis on a circular ring, which axis is inclined by approximately 45E with respect to the axis of symmetry.

Concerning the state of the art, German Patent Document DE 40 13 388 A1 and (Belgian?) Patent Document BE 703747 are also cited which are more remote.

However, separators with more than one drum, which each have one of the disc stacks and drums which can be rotated about more than one axis of rotation are not disclosed or suggested in the state of the art.

Advantageous further developments of the invention are indicated in the subclaims.

Since the centrifuge has two—or even more—centrifugal drums, in which case again preferably one of the axes of rotation is situated inside the at least one or more centrifugal drums, and the other axis of rotation is preferably situated outside the centrifugal drums, a centrifuge is obtained which can more easily be balanced than a centrifuge with only one centrifugal drum, which is necessary because the additional axis of rotation of the centrifugal drum is situated outside the centrifugal drum.

It can be implemented in a compact and uncomplicated manner that the first axes of rotation of the drums are each situated inside the drums and are congruent with an axis of symmetry of the drums, in which case the second axes of rotation perpendicularly cross the first axes of rotation. This arrangement can be implemented, for example, by a dumbbell-type distribution of the drums, the axis of symmetry of the drums in each case representing the first axis of rotation and the two drums being rotated in a dumbbell-type manner about the second axis of rotation. In this case, the solids are transported to the outside in a simple manner as a result of the rotation of the two drums about the joint second axis of rotation, without requiring auxiliary devices for this purpose. In contrast, the disc stacks have an advantageously clarifying effect because they rotate about the first axis of rotation. As a result of the rotation about the second axis outside the disc stack, which is superposed on the rotational speed of the first axis, advantageous flow behaviors are also obtained which differ from those of the state of the art.

Preferably the two centrifugal drums have a double-conical construction, two mutually oppositely oriented conical sections each being constructed at the end area, which is inside relative to the second axis of rotation, and at the end area, which is outside relative to the axis of rotation, of the centrifugal drums. In this case, it is advantageous for the two conical sections of each centrifugal drum to be mutually connected by way of cylindrical sections.

Furthermore, particularly preferably one of the disc stacks with conical discs and preferably rising ducts is in each case arranged concentrically with respect to the inflow pipe in the two centrifugal drums. Solids from the fed or centrifugal material are separated in the disc stack and collected in the solids space (cylindrical) of the centrifugal drum. As a result of the rotation about the second axis A2, the solids are then transported to the outside. Particularly as a result of this construction, it becomes possible to convey the solids by means of the rotation of the two drums about the joint second axis of rotation completely automatically to the outside. A use of the system is conceivable for the purpose of clarification (solid/liquid) and/or of separation (liquid/liquid). As a result of the rotation about the first axis respectively, the effect of the disc stacks is the same as in a normal separator. However the disc stacks can also have discs at the top. The rotational speed at the first axis corresponds to that of a separator.

Since it becomes possible to transport the solids without additional mechanisms out of the drum, in comparison to decanters, this means that neither a planetary gear nor a screw are to be provided for discharging the solids. This also eliminates wear.

In addition, because of the disc stack in the drums, an almost arbitrary clarification surface can be implemented. Mechanical limits as a result of natural frequencies can largely be avoided. It also becomes possible to mount self-cleaning sieve inserts. The energy requirement is relatively low because the solids outlet is situated in the center of the axis of rotation. By means of the open inlet with centrifugal support, overflowing can be avoided. However, not only open but also closed systems, such as centripetal pumps or the like, are conceivable.

In comparison to known separators, it is advantageous that no hydraulic drum system has to be provided for the evacuation. Also, the clogging of nozzles can be avoided because the nozzle diameter can be large in comparison to systems with many small nozzles, and the energy requirement for the solids discharge in the center of the main axis of rotation is low. Under certain circumstances, backwards-oriented nozzles are even conceivable if they do not also rotate about the first axis (can be implemented, for example, by means of floating ring seals) and if the nozzles are arranged on a machine frame which rotates only about the second axis of rotation, which again lowers energy requirements.

However, it should also be noted that it is conceivable to connect the two centrifugal drums behind one another (with respect to the flow path of the centrifugal material) and to, for example, use the first centrifugal drum for a preclarification and the additional centrifugal drum for the fine clarification which follows.

In the following, the invention will be described in detail by means of an embodiment with reference to the drawing.

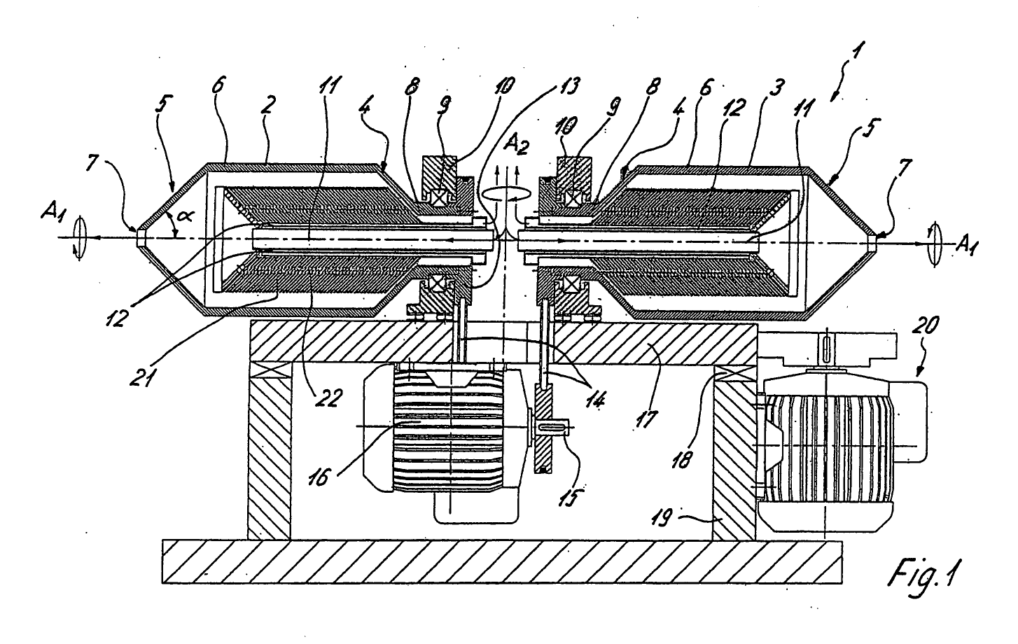

FIG. 1 is a sectional view of a centrifuge according to the invention; and

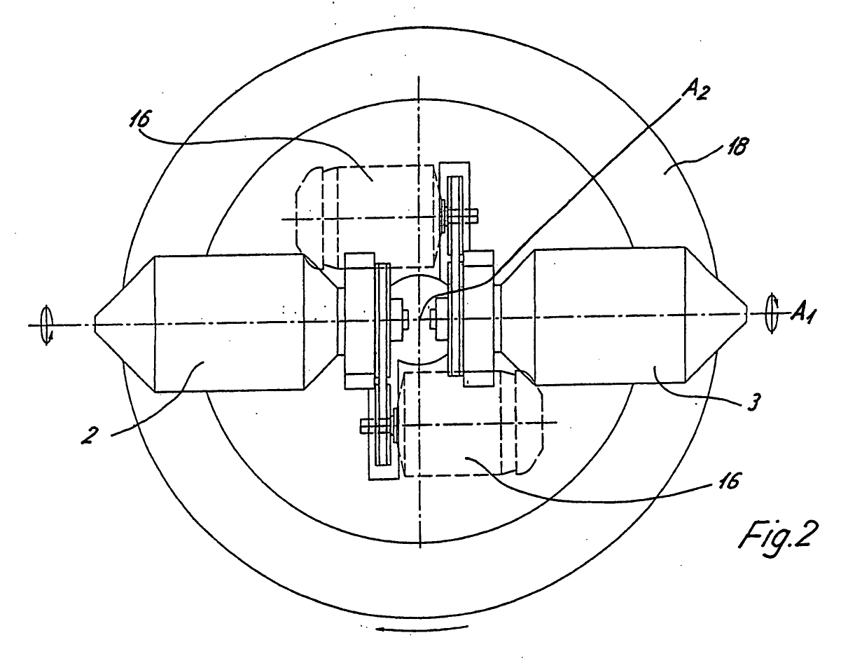

FIG. 2 is a top view of the embodiment of FIG. 1.

FIG. 1 illustrates a centrifuge 1 having two centrifugal drums 2, 3 which are each rotatable about a first axis of rotation A1; here, the horizontal axis of rotation.

The first axes of rotation A1 extend through the centrifugal drums 2, 3, in each case as axes of symmetry in their center of gravity and are aligned here with one another.

The centrifugal drums 2, 3 are arranged opposite one another. However, the first axes of rotation do not have to be mutually aligned. They can also have a different mutual orientation, preferably a parallel mutual alignment.

Furthermore, the centrifugal drums 2, 3 can each also be rotated about a second axis of rotation A2, which here is situated outside the centrifugal drums 2, 3. Here, the two centrifugal drums 2 are rotated jointly “as a whole” about the second axis of rotation A1 situated outside the centrifugal drum 2—preferably in the joint center of gravity of the centrifugal drums 2,3—, which second axis of rotation A2 is situated perpendicular to the first axis of rotation A1 and crosses the latter.

Since, in each case, the first axes of rotation A1 are mutually aligned, and the second axis of rotation A2 is the same for both centrifugal drums 2,3, the construction is simple and clear. Thus, a single driving device 20 is sufficient for the rotation of both centrifugal drums 2, 3 about the second axis of rotation A2.

The centrifugal drums 2, 3 have a double-conical construction, two mutually oppositely oriented conical sections 4, 5 each being constructed at the end area, which is inside relative to the second axis of rotation A2, and at the end area, which is outside relative to the second axis of rotation A2, of the centrifugal drums and are in each case mutually connected by way of central cylindrical sections 6. In the area of sections 4, 5, 6, the centrifugal drums have a continuous basket shell.

At the outside ends of the outer conical sections 5, discharge openings 7 (nozzles) are constructed, particularly for a solids phase and are oriented concentrically to the first axis of rotation A1. Relative to the first axis of rotation A1, the outer conical sections 5 are each preferably conically at an acute angle, the angle of taper a with respect to the first axis of rotation amounting to 60° and less, so that wear effects as a result of solids exiting from the nozzles on the drum basket shell are largely avoided. This angle α is selected such that the solids can advantageously slide off on this angle.

In the direction of the second axis of rotation A2, the inner conical sections 4 are followed by cylindrical attachments 8 which are rotatably disposed by means of bearing systems, particularly by means of suitable ball bearings 9, in carrier elements 10, which absorb axial and radial forces. It is also conceivable to provide additional bearing systems (not shown here) in the outer area of the centrifugal drums (for example, following the conical areas on cylindrical attachments or the like (not shown here)).

One centric feeding pipe 11 respectively for the centrifugal material extends through the cylindrical attachments 8 and, for example, discharge ducts 12 arranged concentrically and/or parallel to these pipes, for discharging a lighter phase, such as a liquid phase, which ducts 12 may be connected toward the interior—with respect to the second axis of rotation A2—with additional inlet and discharge pipes (not shown here) (through the second axis of rotation). The function of the feeding pipe 11 and the discharge ducts 12 can also be reversed—with a corresponding modification of the connections). It is also conceivable to connect the two centrifugal drums fluidically behind one another.

Toward the interior, pulleys 13 are placed on the cylindrical attachments 8, which pulleys 13 are connected by way of driving belts 14 with output shafts 15 of first driving devices 16, particularly electric motors or hydraulic motors, which are preferably arranged parallel to the centrifugal drums 2 on opposite sides of the centrifugal drums 2 in order to implement an arrangement which is as free of imbalances as possible. Instead of a belt drive (for example, with flat belts, V-belts or toothed belts), chain drives or direct-acting transmissions, such as toothed gearings, or the like, are conceivable.

The two driving devices 16 as well as the carrier elements 10, which carry the centrifugal drums 2, 3, are arranged on a rotatable carrier-type ring 17, through whose center the second axis of rotation A2 extends, the centrifugal drums 2, 3 being above and the first driving devices 16 being situated below the ring 17. In addition, it is conceivable to arrange the centrifugal drums 2, 3 between an upper and a lower ring (not shown here) or to arrange the driving devices also above the ring 17 (here also not shown.) Finally, the two centrifugal drums 2, 3 may also have a joint driving device 16 for driving the centrifugal drums 2, 3 about the first axis of rotation A1; for example, a driving motor with two pulleys on a joint output shaft or the like.

By means of bearings 18, the horizontally aligned ring 17 is rotatably disposed on a base structure 19 and can be rotated by means of a second driving device 20 on the base structure 19. The bearing 18 absorbs the axial as well as the radial forces and can also be implemented in a different fashion.

One disc stack 21 respectively having conical discs is arranged concentrically with respect to the feeding pipe 10 in the two centrifugal drums 2, 3, which disc stack 21 can be provided with rising ducts 22 and can have a construction analogous to the disc stacks of separators.

During the operation, the two centrifugal drums 2, 3 rotate at a higher first rotational speed about the first axis of rotation A1. In this manner, a circumferential speed about the first axis of rotation A1 at the outer drum diameter can be reached which is known from decanters or, under certain circumstances, even from separators; for example, a circumferential speed of more than 80 m/sec. Whereas, the two centrifugal drums 2,3 preferably rotate about the second axis of rotation A2 at a lower circumferential speed (a subcritical operation is preferred). The term “subcritical operation” indicates a rotational speed below the first resonance frequency of the separator.

Centrifugal material in each case fed through the feeding pipe 11 enters into the centrifugal drums 2, 3, where liquids of different densities collect on different radii and are discharged through one or more discharge pipes or centripetal pumps, or the like. According to FIG. 1, only one liquid phase is discharged in each centrifugal drum 2, 3.

The solid phases collect in each case on the inner circumference of the centrifugal drums 2, 3, and, as a result of the rotation of the centrifugal drums 2, 3 about the second axis of rotation A2, move toward the outside in the latter, where they move in outer conical sections 5 to the discharge openings 7, move out of the centrifugal drums and are collected in a manner not shown here, for example, in an outer ring-type collecting device or the like.

It is noted here that it is a special advantage that an almost “automatic” solids discharge is implemented through the discharge opening 7 in the outer conical sections 5, without the requirement to provide auxiliary devices for the solids discharge, such as a screw, in the drum. In contrast to separator drums, the clogging of the nozzles can also be avoided. Although additional centrifugal forces act upon the system here, by means of a suitable compensation and a suitable distribution of the masses—particularly by a suitable -arrangement of the driving motors and by mass-balancing weights (not shown)—, these forces can be kept within comprehensible limits.

As a result of the fact that several centrifugal drums 2, 3 are provided, the capacity of each centrifuge is relatively large. It is even conceivable to arrange, instead of two centrifuges, also three, four or more centrifuges evenly distributed around the second axis of rotation on the circumference.

### REFERENCE SYMBOLS

Centrifuge 1

centrifugal drums 2,3

conical sections 4, 5

cylindrical sections 6

discharge openings 7

cylindrical attachments 8

bearing 9

carrier elements 10

feeding pipe 11

discharge ducts 12

pulleys 13

driving belt 14

output shafts 15

1st driving device 16

ring 17

bearing 18

base structure 19

2nd driving device 20

disc 21

rising ducts 22

1. Centrifuge having at least one centrifugal drum, having a stack of discs (21), characterized in that
a) the centrifuge has at least two centrifugal drums (2,3) which can each be rotated about two axes of rotation (A1, A2)
b) one of the axes of rotation respectively extending through the center of gravity of the centrifugal drums such that one of the axes of rotation (A1) is in each case situated within the at least one or more centrifugal drum(s) and the other axis of rotation (A2) is preferably situated outside the centrifugal drum(s) (2, 3),
c) one of the disc stacks (21) respectively being inserted into the drums.

2. Centrifuge according to claim 1, characterized in that the two axes of rotation extending through the center of gravity are oriented parallel to one another and, in particular, are aligned with one another.

3. Centrifuge according to claim 1 or 2, characterized in that the centrifugal drums (2, 3) have a continuous basket shell.

4. Centrifuge according to one of the preceding claims, characterized in that one of the axes of rotation (A1) is in each case situated inside the at least one or more centrifugal drum(s), and the other axis of rotation (A2) is situated outside the centrifugal drum(s) (2,3).

5. Centrifuge according to one of the preceding claims, characterized in that the maximal rotational speed of the centrifugal drums (2, 3) about the first axis of rotation (A1) is higher than the maximal rotational speed about the second axis of rotation (A2).

6. Centrifuge according to one of the preceding claims, characterized in that the two centrifugal drums (2, 3) are arranged opposite one another, and in that the first axes of rotation (A1) of the two centrifugal drums (2, 3) are aligned with one another.

7. Centrifuge according to one of the preceding claims, characterized in that the second axis of rotation (A2) is arranged perpendicular to the first axis of rotation (A1) and crosses the first axis of rotation (A1).

8. Centrifuge according to one of the preceding claims, characterized in that the two centrifugal drums (2, 3) have a double-conical construction, two mutually oppositely oriented conical sections (4, 5) each being constructed at the end area, which is inside relative to the second axis of rotation (A2), and at the end area, which is outside relative to the axis of rotation, of the centrifugal drums (2, 3).

9. Centrifugal drum according to one of the preceding claims, characterized in that the two conical sections (4, 5) of each centrifugal drum (2, 3) are mutually connected by way of central cylindrical sections (6).

10. Centrifuge according to one of the preceding claims, characterized in that, relative to the first axis of rotation (A1), the outer conical sections 5 are each preferably conically constructed at an acute angle, the angle of taper a with respect to the first axis of rotation (A1) amounting to 60E and less.

11. Centrifuge according to one of the preceding claims, characterized in that the disc stack (21) with conical discs (21) is in each case arranged concentrically with respect to the feeding pipe (10) in both centrifugal drums (2, 3).

12. Centrifuge according to one of the preceding claims, characterized in that the disc stack (21) has rising ducts (22).

13. Centrifuge according to one of the preceding claims, characterized in that, at the outer end of the outer conical sections (5), discharge openings (7) for a solid phase are constructed which are oriented concentrically with respect to the first axis of rotation (A1).

14. Centrifuge according to one of the preceding claims, characterized in that cylindrical attachments (8) are shaped onto the inner conical sections (4) toward the second axis of rotation (A2), which attachments (8) are disposed in the carrier elements (10) by means of bearings (9).

15. Centrifuge according to one of the preceding claims, characterized in that, in each case, one centric feeding pipe (11) for the centrifugal material and discharge ducts (12) extend through the cylindrical attachments (8).

16. Centrifuge according to one of the preceding claims, characterized in that each centrifugal drum (2, 3) has a first driving device (16) for driving the centrifugal drum (2, 3) about the first axis of rotation (A1).

17. Centrifuge according to one of the preceding claims, characterized in that the two centrifugal drums (2, 3) have a common driving device (16) for driving the centrifugal drum (2, 3) about the first axis of rotation (A1).

18. Centrifuge according to one of the preceding claims, characterized in that the two centrifugal drums (2, 3) as well as the two driving devices (16) are arranged on at least one ring (17) which is rotatably disposed.

19. Centrifuge according to one of the preceding claims, characterized in that the ring (17) is horizontally aligned and is rotatably disposed by means of bearings (18) on a base structure (19).

20. Centrifuge according to one of the preceding claims, characterized in that the ring (17) can be rotated on the base structure (19) by means of a second driving device (20).

21. Centrifuge according to one of the preceding claims, characterized in that the two centrifugal drums (2, 3) are connected behind one another with respect to the flow path of the centrifugal material.
